(19) United States
(12) Patent Application Publication
(10) Pub. No.: US 2025/0322543 A1
(43) Pub. Date: Oct. 16, 2025

(54) DEVICE AND METHOD FOR CONTROLLING AN ILLUMINATION IN A DIGITAL IMAGE

(71) Applicant: Robert Bosch GmbH, Stuttgart (DE)

(72) Inventors: Konrad Groh, Stuttgart (DE); Jan Hendrik Metzen, Boeblingen (DE); Sezer Karaoglu, Amsterdam (NL); Tao Hu, München (DE); Theo Gevers, Amsterdam (NL); Xiaoyan Xing, Amsterdam (NL)

(21) Appl. No.: 19/172,711

(22) Filed: Apr. 8, 2025

(30) Foreign Application Priority Data
Apr. 11, 2024 (EP) 24 16 9747.3

(51) Int. Cl. G06T 7/90

(52) U.S. Cl. CPC G06T 7/90; G06T 2207/10152; G06T 2207/20081

(57) ABSTRACT

A method for controlling an illumination in a digital image. The method includes providing target illumination properties that include the target brightnesses of pixels of the digital image; determining the digital image that optimizes a first similarity metric that depends on the target illumination properties and on illumination properties that comprise the brightnesses of the pixels of the digital image.

### CROSS REFERENCE

The present application claims the benefit under 35 U.S.C. § 119 of European Patent Application No. EP 24 16 9747.3 filed on Apr. 11, 2024, which is expressly incorporated herein by reference in its entirety.

### FIELD

The present invention relates to a device and a method for controlling an illumination in a digital image.

### BACKGROUND INFORMATION

Generative models may be used to synthesize digital images from text prompts. Exemplary generative models are DALL-E, CLIP, CM3leon. These models have only limited control over the illumination of the digital image.

Renderer may be used to control the physics, in particular illumination, of a scene in the digital image. An example for a renderer is Blender.

### SUMMARY

A device and method for controlling an illumination according to the present invention combines physics-guided and training-free diffusion for controlling the illumination in a digital image.

The method according to the presnet invention generates photo-realistic illumination conditions under the proper illumination property guidance. The method is able to control the illumination of an original digital image or of a generated digital image. Controlling the illumination of the original digital image is referred to as performing illumination editing of the original digital image. An example of the illumination editing is adding a new illumination to the original digital image. An example of illumination editing is relighting, e.g., of a face depicted in the digital image.

Illumination is related to the brightness of a pixel of the digital image. Controlling the illumination is a manipulation of the low-level features of the digital image that define the illumination, i.e., the brightnesses of the pixels of the digital image.

The method is training-free and easily integrated with most pixel-based diffusion models. This enhances the illumination control capabilities of pixel-based diffusion models efficiently.

According to an example embodiment of the present invention, the method for controlling the illumination in a digital image, in particular for enhancing a training data set, comprises providing target illumination properties that comprise the target brightnesses of pixels of the digital image, determining the digital image that optimizes a first similarity metric that depends on the target illumination properties and on illumination properties that comprise the brightnesses of the pixels of the digital image.

To control the illumination conditions in a generated digital image or an original digital image, the first similarity metric comprises pixel-wise differences between the illumination properties and the target illumination properties, and wherein determining the digital image that optimizes the first similarity metric comprises determining the digital image that minimizes the sum of the pixel-wise differences.

To control the illumination conditions of the original digital image, the digital image comprises a first color channel and a second color channel, wherein the method comprises providing target geometry properties that comprise a target cross color ratio for the combination of the first color channel and the second color channel for a pair of pixels of the digital image, determining the digital image that optimizes a second similarity metric that depends on the target geometry properties and on geometry properties that comprise a cross color ratio for the combination of the first color channel and the second color channel of the digital image for the pair. This introduces geometry guidance.

The pair may comprise a first pixel and a second pixel, wherein the cross color ratio for the pair comprises, the product of a ratio of the intensity of the color of the first pixel in the first color channel and the intensity of the color of the second pixel in the first color channel, with a ratio of the intensity of the color of the first pixel in the second color channel and the intensity of the color of the second pixel in the second color channel.

The second similarity metric may comprise pixel-wise differences between the geometry properties and the target geometry properties of a plurality of pairs of pixels of the digital image, and wherein determining the digital image that optimizes the second similarity metric comprises determining the digital image that minimizes the sum of the pixel-wise differences of the second similarity metric.

The target geometry properties and the geometry properties may comprise the cross color ratios only for pairs of neighboring pixels of the digital image.

According to an example embodiment of the present invention, the digital image may comprise the first color channel, the second color channel, and a third color channel, wherein the target geometry properties and the geometry properties comprise the cross color ratios for the combination of the first color channel and the third color channel, and the combination of the second color channel and the third color channel.

According to an example embodiment of the present invention, for enhancing the training data set, the method may comprise providing a set of different target geometry properties, and generating different digital images with different target geometry properties from the set.

According to an example embodiment of the present invention, for enhancing the training data set, the method may comprise providing a set of different target illumination properties, and generating different digital images with different target illumination properties from the set.

According to an example embodiment of the present invention, the device for controlling the illumination in the digital image, in particular for enhancing the training data set comprises at least one processor and at least one storage, wherein the at least one storage stores instructions that are executable by the at least one processor, and that, when executed by the at least one processor, cause the device to execute the method.

According to an example embodiment of the present invention, a computer program for controlling an illumination in a digital image may comprise computer readable instructions that, when executed by a computer, cause the computer to execute the method.

Further embodiments of the present invention may be derived from the following description and the figures.

### BRIEF DESCRIPTION OF THE DRAWINGS

FIG. 1 schematically depicts a device for controlling an illumination in a digital image, according to an example embodiment of the present invention.

FIG. 2 depicts a flow chart with steps of a first example of a method for controlling the illumination, according to the present invention.

FIG. 3 depicts a flow chart with steps of a second example of the method for controlling the illumination, according to the present invention.

### DETAILED DESCRIPTION OF EXAMPLE EMBODIMENTS

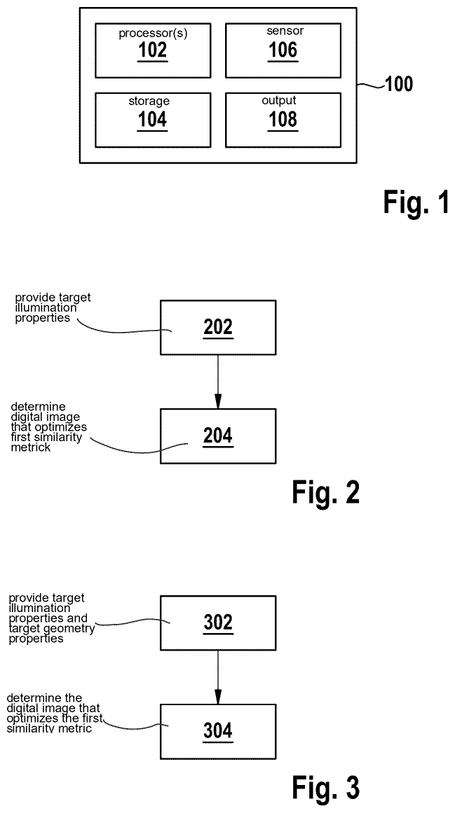

FIG. 1 schematically depicts a device 100 for controlling an illumination in a digital image x.

The device 100 comprises at least one processor 102 and at least one storage 104. The device 100 may be a cellular phone. The device 100 may comprise a sensor 106 that is configured for capturing an original digital image x₀. The sensor 106 is for example a camera or a receiver.

The device 100 may comprise an output 108 that is configured for outputting the digital image x. The output 108 is for example a display or a sender.

The at least one storage 104 stores instructions that are executable by the at least one processor 102.

When executed by the at least one processor 102, the instructions cause the device 100 to execute a method for controlling an illumination of the digital image x.

A computer program for controlling the illumination comprises computer readable instructions that, when executed by a computer, cause the computer to execute the method.

Diffusion models gradually perturb data using a forward diffusion process and then reverse the process to reconstruct the original data.

Let q(x₀) denote an unknown data distribution in [symbol] . The forward diffusion process, indexed by step t as {xₜ}_{t∈[0,T]}, is succinctly represented by the following forward Stochastic Differential Equation (SDE):

$$d x = f ( x , t ) dt + g ( t ) dw$$

where w∈ [symbol] is a standard Wiener process f(·,t): [symbol] → [symbol] is the drift coefficient and g(t)∈ [symbol] is the diffusion coefficient.

The f(x,t) and g(t) are related to the noise size and determine the perturbation kernel q_{t|0}(xₜ|x₀) from step 0 to step t.

Let q_{t|0}(x) be the marginal distribution of the SDE at step t, the step-reversal is described by another SDE:

$$d x = [ f ( x , t ) dt + {g ( t )}^{2} s ( x , t ) ] dt + g ( t ) d \overline{w}$$

where w is a reverse-step standard Wiener process with dt as an infinitesimal negative step, and s(x,t)=∇ₓ log qₜ(x) represents a score.

The score, similar to energy, allows to introduce an additional energy function ε(.,.,.) into the reverse SDE process for the specific guidance.

The method is described by way of example of two tasks.

According to a first example, the method controls the illumination conditions of a generated digital image. According to a second example, the method controls the illumination conditions of an original digital image.

To accomplish these tasks, the energy function in the diffusion process is reformulated. Then illumination guidance is introduced in the image synthesis with the diffusion model.

To accomplish the second task, additionally, geometry guidance is introduced.

Notably, this change to the diffusion model requires no further training, nor extra data labels or Computer Generated Imagery, CGI techniques.

The design of the energy function & is decomposed into the sum of two log potential functions:

$$ε ( y , x , t ) = {λ}_{I} {ε}_{I} ( y , x , t ) + {λ}_{R} {ε}_{R} ( y , x , t ) = {λ}_{I} {E}_{{q}_{t \vert o} ( {x}_{t} \vert x )} {S}_{I} ( y , x , t ) + {λ}_{R} {E}_{{q}_{t \vert 0} ( {x}_{t} \vert x )} {S}_{R} ( y , x , t )$$

where y is the target guidance for the respective energy ε, ε_{R}, where ε, (.,.,.): [symbol] × [symbol] × [symbol] → [symbol] is the log potential function provided for illumination-based guidance, and ε_{R}(.,.,.): [symbol] × [symbol] × [symbol] → [symbol] is the log potential function provided for geometry-based guidance, xₜ is the perturbation source image in the forward SDE, and q_{t|0}(xₜ|x) is the perturbation kernel from step 0 to step t in the forward SDE.
Sₗ(y,x,t): [symbol] × [symbol] × [symbol] → is a function measuring a similarity between a target illumination guidance and perturbed source image.

S_{R}(y,x,t): [symbol] × [symbol] × [symbol] → is a function measuring a similarity between a target geometry guidance and perturbed source image. λₗ, λ_{R} are weighting hyper-parameters that may be predetermined.

In the reverse process, adopting a step size of h, the iteration rule from s to t=s-h is as

$${x}_{t} = {x}_{s} - [ f ( x , s ) - {g ( s )}^{2} ( s ( {x}_{s} , s ) - {∇}_{x} ε ( y , x , s ) ) ] h + g ( s ) \sqrt{h} z$$

where z˜N(0,I) and N is the normal distribution. The expectation in ε(y,x,s) is for example estimated by the Monte Carlo method of a single sample.

FIG. 2 depicts a flow chart with steps of a first example of the method.

According to the first example, the digital image x is generated in iterations with the diffusion model.

The digital image x is in the example determined in iteration steps t. The input digital image xₜ of an iteration t is a digital image xₜ₋₁ that is determined in the iteration xₜ₋₁ preceding iteration xₜ. The digital image x in the example is the digital image xₜ of a last iteration t.

According to the first example, the method controls the illumination of the digital image x that is generated with the diffusion model.

According to the first example, the method comprises a step 202.

The step 202 comprises providing target illumination properties that comprise the target brightnesses of pixels of the digital image x.

According to an example, the target illumination properties are provided by parameterizing an illumination map as a composition of N two-dimensional Gaussian functions G as:

$${y}_{s} = {\sum }_{i = 1}^{N} {α}_{i} G ( {μ}_{i} , {\sum }_{i} )$$

wherein the mean μᵢ represents the position of the light source for the visible lights source or the location of the brightest parts of the digital image x for the invisible light source, and wherein the co-variance matrix Σᵢ describes the spread and directionality of the light. αᵢ is the wight of the corresponding Gaussian, which, for example, is subject to Σαᵢ=1.

According to the first example, the method comprises a step 204.

The step 204 comprises determining the digital image x that optimizes a first similarity metric Sₗ(yₛ,xₜ,t). In the example, the first similarity metric Sₗ(yₛ,xₜ,t) is differentiable.

The digital image x is in the example determined depending on the first similarity metric Sₗ(yₛ,xₜ,t) in iteration steps t.

According to an example, the first similarity metric Sₗ(yₛ,xₜ,t) quantifies a difference between the target illumination properties yₛ and illumination properties fₛ(xₜ) of the digital image xₜ.

In the example, the method comprises determining the digital image x that minimizes the first similarity metric Sₗ(yₛ,xₜ,t).

The first similarity metric Sₗ(yₛ,xₜ,t) depends on the target illumination properties yₛ and on the illumination properties fₛ(xₜ).

The illumination properties fₛ(xₜ) comprise the brightnesses of the pixels of a digital image xₜ.

The illumination properties fₛ(xₜ) for a digital image xₜ having three color channels, e.g., red, r, green, g, blue, b, comprise for example the estimated lighting at pixel mynt at a given iteration step t:

$${f}_{s} ( {x}_{t} ) = {f}_{s} ( {m}_{t} {n}_{t} ) = {\sum }_{r , g , b} {\sum }_{k = 1}^{N} {w}_{k} ( \frac{1}{2 π {σ}_{k}^{2}} ) {e}^{- \frac{{t}^{2} + {j}^{2}}{2 {σ}_{k}^{2}}} * {x}_{t} ( {m}_{t} , {n}_{t} )$$

wherein {i,j} represents the position of the Gaussian center, ok is the standard deviation for the k-th scale, and * denotes the convolution.

The method is neither limited to three color channels, nor to the colors red, green, blue. Other colors and more or less than three color channels may be used alike, e.g., by adjusting the outer sum according to the channels.

This means, digital images with more or less than three color channels may be processed, or less than all of the available color channels of a digital image may be processed.

According to an example the first similarity metric Sₗ(yₛ,xₜ,t) comprises, pixel-wise differences between the illumination properties fₛ(xₜ) and the target illumination properties yₛ. In the example the pixel-wise mean square error is used to calculate the difference at iteration t:

$${S}_{I} ( {y}_{s} , {x}_{t} , t ) = {\sum }_{( {m}_{t} , {n}_{t} ) ∈ {x}_{t}} {‖ {f}_{s} ( {x}_{t} ) - {y}_{s} ‖}_{2}$$

FIG. 3 depicts a flow chart with steps of a second example of the method for controlling the illumination.

According to the second example, the method controls the illumination and the geometry of the digital image x that is generated with the diffusion model.

According to the second example, the method comprises a step 302.

The step 302 comprises providing the target illumination properties yₛ and target geometry properties y_{c}.

According to an example, target geometry properties y_{c} are provided

According to the second example, the method comprises a step 304.

The step 304 comprises determining the digital image x that optimizes the first similarity metric Sₗ(yₛ,xₜ,t) and a second similarity metric S_{R}(y_{c}, xₜ,t). In the example, the second similarity metric S_{R}(y (, xₜ,t) is differentiable.

The digital image x is in the example determined depending on the first similarity metric Sₗ(yₛ,xₜ,t) and the second similarity metric S_{R}(y_{c}, xₜ,t) in iteration steps t.

According to an example, the second similarity metric S_{R}(y_{c}, xₜ,t) quantifies a difference between the target geometry properties y_{c} and geometry properties f (x) of the digital image xₜ. In the example, the method comprises determining the digital image x that minimizes the sum of the first similarity metric Sₗ(yₛ,x,t) and second similarity metric S_{R}(y_{c}, xₜ,t).

The second similarity metric S_{R}(y_{c}, xₜ,t) depends on the target geometry properties y_{c} and on the geometry properties fc (xₜ).

The geometry properties fc (xₜ) comprise cross color ratio of the pixels of a digital image xₜ.

According to an example, the target geometry properties y,and the geometry properties fc (xₜ) for the digital image xₜ having the three color channels, e.g., red, r, green, g, blue, b, are determined for different combinations of channels and pairs of pixels of the digital image xₜ.

This is described by way of example of a first color channel R, a second color channel G, a third color channel B. The method is neither limited to three color channels nor to the colors red, green, blue. The cross color ratio may be determined for two color channels, more or more than three color channels.

According to an example, the cross color ratio is determined for neighboring pixels only. A pixel is a neighbor of another pixel in case the pixels are adjacent.

The cross color ratio is described for an exemplary pair of pixels that comprises a first pixel p₁ and a second pixel p₂ of the digital image xₜ.

For the combination of the first color channel R and the second color channel G, the cross color ratio for the pair comprises, the product

$${M}_{RG} = \frac{{R}_{p 1} {G}_{p 2}}{{R}_{p 2} {G}_{p 1}}$$

of a ratio

$$\frac{{R}_{p 1}}{{R}_{p 2}}$$

of the intensity of the color of the first pixel p in the first color channel R and the intensity of the color of the second

$$\frac{{G}_{p 2}}{{G}_{p 1}}$$

pixel p₂ in the first color channel R, with a ratio of the intensity of the color of the first pixel pj in the second color channel G and the intensity of the color of the second pixel p₂ in the second color channel G.

The cross color ratio for the combination of the first color channel R and the third color channel B is:

$${M}_{R B} = \frac{{R}_{p 1} {B}_{p 2}}{{R}_{p 2} {B}_{p 1}}$$

The cross color ratio for the combination of the second color channel G and the third color channel B is:

$${M}_{G B} = \frac{{G}_{p 1} {B}_{p 2}}{{G}_{p 2} {B}_{p 1}}$$

In this context, for the original digital image x₀∈ [symbol] a cross color ratio matrix Cₓ_{₀} ∈ [symbol] of the original digital image x₀ with three color channels is

$${C}_{{x}_{0}} = [ {M}_{RG} , {M}_{RB} , {M}_{G B} ]$$

wherein H×W represents the height H and the width W of the original digital image x₀.

In this context, the cross color ratio matrix of the generated digital image xₜ at step t is

$${C}_{{x}_{t}} = {f}_{c} ( {x}_{t} )$$

According to an example the second similarity metric S_{R}(y_{c}, xₜ,t) comprises pixel-wise differences between the geometry properties fc (xₜ) and the target geometry properties y_{c}. In the example the pixel-wise mean square error is used to calculate the difference at iteration t:

$${S}_{R} ( {y}_{c} , {x}_{t} , t ) = {\sum }_{( {m}_{t} , {n}_{t} ) ∈ {x}_{t}} {‖ {f}_{c} ( {x}_{t} ) - {y}_{c} ‖}_{2}$$

The method for example comprises manipulating an input digital image or an input digital image of a video. The method for example comprises a correction of the input digital image, e.g., an illumination correction.

For enhancing a training data set, the method according to the first example comprises providing a set of different target illumination properties yₛ, and generating different digital images with different target illumination properties yₛ from the set.

For enhancing a training data set, the method according to the second example additionally comprises providing a set of different target geometry properties y_{c}, and generating different digital images with different target geometry properties y_{c} from the set.

What is claimed is:

1. A method for controlling an illumination in a digital image for enhancing a training data set, the method comprising the following steps:
providing target illumination properties that include target brightnesses of pixels of the digital image; and
determining the digital image that optimizes a first similarity metric that depends on the target illumination properties and on illumination properties that include brightnesses of the pixels of the digital image.

2. The method according to claim 1, wherein the first similarity metric includes pixel-wise differences between the illumination properties and the target illumination properties, and wherein the determining of the digital image that optimizes the first similarity metric includes determining the digital image that minimizes a sum of the pixel-wise differences.

3. The method according to claim 1, wherein the digital image includes a first color channel and a second color channel, and wherein the method further comprises:
providing target geometry properties that include a target cross color ratio for a combination of the first color channel and the second color channel for a pair of pixels of the digital image;
determining the digital image that optimizes a second similarity metric that depends on the target geometry properties and on geometry properties that include a cross color ratio for the combination of the first color channel and the second color channel of the digital image for the pair.

4. The method according to claim 3, wherein the pair includes a first pixel and a second pixel, wherein the cross color ratio for the pair includes, a product of a ratio of the intensity of color of the first pixel in the first color channel and an intensity of color of the second pixel in the first color channel, with a ratio of the intensity of the color of the first pixel in the second color channel and the intensity of the color of the second pixel in the second color channel.

5. The method according to claim 3, wherein the second similarity metric includes pixel-wise differences between the geometry properties and the target geometry properties of a plurality of pairs of pixels of the digital image, and wherein the determining of the digital image that optimizes the second similarity metric includes determining the digital image that minimizes the sum of pixel-wise differences of the second similarity metric.

6. The method according to claim 3, wherein the target geometry properties and the geometry properties include the cross color ratios only for pairs of neighboring pixels of the digital image.

7. The method according to claim 3, wherein the digital image includes the first color channel, the second color channel, and a third color channel, wherein the target geometry properties and the geometry properties comprise the cross color ratios for the combination of the first color channel and the third color channel, and the combination of the second color channel and the third color channel.

8. The method according to claim 3, wherein, for enhancing the training data set, the method includes providing a set of different target geometry properties, and generating different digital images with different target geometry properties from the set.

9. The method according to claim 1, wherein, for enhancing the training data set, the method includes providing a set of different target illumination properties, and generating different digital images with different target illumination properties from the set.

10. A device configured to control an illumination in a digital image for enhancing a training data set, the device comprising:
at least one processor; and
at least one storage, wherein the at least one storage stores instructions that are executable by the at least one processor, and that, when executed by the at least one processor, cause the device to execute a method including the following steps:
providing target illumination properties that include target brightnesses of pixels of the digital image, and
determining the digital image that optimizes a first similarity metric that depends on the target illumination properties and on illumination properties that include brightnesses of the pixels of the digital image.

11. A non-transitory computer-readable medium on which is stored a computer program for controlling an illumination in a digital image for enhancing a training data set, the computer program, when executed by a least one processor, causing the at least one processor to perform the following steps:
providing target illumination properties that include target brightnesses of pixels of the digital image, and
determining the digital image that optimizes a first similarity metric that depends on the target illumination properties and on illumination properties that include brightnesses of the pixels of the digital image.
